(19) United States
(12) Patent Application Publication
(10) Pub. No.: US 2024/0368027 A1
(43) Pub. Date: Nov. 7, 2024

(54) ENAMEL PASTE COMPOSITIONS, ENAMEL COATED PRODUCTS, AND METHODS OF MANUFACTURING THE SAME

(71) Applicant: FENZI AGT NETHERLANDS B.V., Maastricht (NL)

(72) Inventors: Olivier Jean André DESANTE, Maastricht (NL); Jean Luc LOONTJENS, Maastricht (NL); Martin Paul Ernest TRIEPELS, Maastricht (NL); Maxence VALLA, Maastricht (NL)

(21) Appl. No.: 18/288,022

(22) PCT Filed: Apr. 14, 2022
(86) PCT No.: PCT/NL2022/050205

§ 371 Date: Oct. 23, 2023

(30) Foreign Application Priority Data
Apr. 21, 2021 (GB) 2105702.1

(51) Int. Cl. C03C 8/22; C03C 10/00; C03C 17/04

(52) U.S. Cl. CPC C03C 8/22; C03C 10/0054; C03C 17/04; C03C 2217/452; C03C 2217/485

(57) ABSTRACT

An enamel paste composition is provided for fabricating a coated glass article includes a glass substrate, an enamel layer disposed on the glass substrate, and a thin coating having a thickness of no greater than 0.5 micrometres disposed on the enamel layer. The enamel paste composition is formulated such that it provides a smooth surface and does not crystallize during processing of the coated glass article, thereby improving the quality of the thin coating disposed thereon.

### FIELD

The present specification relates to enamel paste compositions, enamel coated products, and methods of manufacturing the same.

### BACKGROUND

In the automotive glazing industry, it is common to decorate windshields, back and side lights, and other glass components with a black band of obscuration enamel extending around a peripheral region of the components. A primary function is to shield the glue that holds the glass components in place from ultraviolet radiation which would otherwise decompose the glue. A secondary function is to cover up electrical circuits, wires, and connectors that ensure functionality of electrical or electronic components attached to, or embedded into, the glass component and ensure a clean aesthetic appearance.

Enamels typically comprise glass frit and pigment in an organic carrier medium. The enamels are applied as a paste or ink in a screen printing or ink jet process to a flat glass substrate and are subsequently fired at high temperatures, during which the organic carrier medium of the paste or ink burns off and the enamel fuses together and establishes a bond to the substrate. The firing process also softens the substrate which can be formed into the final shape by a bending process during the firing process. It is also known to use a two-step firing process to form an enamel layer, the process comprising: (i) a first “pre-firing” heating step, at a temperature below the melting temperature of the glass frit in the enamel paste, in order to remove organic carrier medium components of the enamel paste, thus forming a dry, pre-fired layer; and (ii) a second “firing” heating step at a temperature above the melting point of the glass frit in the enamel paste to fuse the enamel. During the second firing step the substrate can be formed into the final shape by a bending process.

In addition to obscuration enamels, electrical components can also be printed onto a glass component in a similar manner. In this case, the enamel formulation will typically comprise a metallic, electrically conductive powder (e.g. silver powder), glass frit, and an organic carrier medium. Such conductive enamel pastes can be applied in addition to the obscuration enamel pastes and fired in the same process to form a glass component which comprises both electrical components (e.g. antennae and/or heating elements) and obscuration enamel, with the obscuration enamel arranged to obscure electrical connections (e.g. bus bars) to the electrical components.

More recently, functional thin films have also been applied to glass components using, for example, a vapour deposition process. Such functional thin films are of a nanometre scale thickness and can function, for example, as heating elements (substituting the more screen or inkjet printed conductive silver-enamel heater lines) and/or IR reflective elements.

US20170135160 (granted as U.S. Pat. No. 10,455,645B2) describes an example of a method for fabricating a motor vehicle glass panel comprising a system of thin, sputtered conductive layers for heating the glass panel. The glass panel configuration described in US20170135160 is shown in FIG. 1 and comprises two glass sheets 2, 4 united by an interlayer sheet 6. In use, glass sheet 2 forms the outer glass sheet of the glass panel while glass sheet 4 forms the inner glass sheet. The sides of the glass sheets in a motor vehicle glass panel are conventionally numbered from the outside towards the inside. As such, the outer side 8 of outer glass sheet 2 is conventionally designated side 1, the inner side 10 of outer glass sheet 2 is conventionally designated side 2, the side 12 of the inner glass sheet 4 which faces the outer glass sheet 2 is conventionally designated side 3, while the interior side 14 of inner glass sheet 4 is conventionally designated side 4. In the configuration of US20170135160 shown in FIG. 1, an enamel layer 16 is formed on side 2 of the outer glass sheet. A thin coating 18 is formed over the enamel layer 16 and over uncoated portions of side 2 of the outer glass sheet. In US20170135160, the thin coating is a system of heated conductive layers formed by cathode sputtering and comprising an assembly of metal layers and of dielectric layers, the assembly exhibiting a thickness which may be 0.1 micrometres or less. An electrical bus bar 20 is then formed on the thin coating 18 over the enamel layer 16. As previously indicated, US20170135160 discloses that the system can be fired in a two-step firing process including a first pre-firing step to remove organic carrier medium and a second firing step at higher temperature to melt and fuse the glass frit, bending being performed during the second firing step of the firing process to form the shaped glass article. US20170135160 discloses a problem with the configuration illustrated in FIG. 1 and described above. Namely, US20170135160 identifies that the power delivered to the busbars is not completely transmitted to the conductive layers and this results in a loss of power, adversely affecting heating performance of the glass panel. US20170135160 identifies that this problem is at least partially caused by surface roughness of the enamel layer adversely affecting the overlying conductive coating and the connection of the bus bar to the conductive coating over the enamel layer. As such, US20170135160 describes that the surface roughness Rₐ of the enamel layer should be no greater than 0.5 micrometres and preferably no greater than 0.1 micrometres. Several methods are described for reducing the roughness of the enamel layer including: (i) use of an enamel composition comprising glass frit and pigment, wherein the mean particle size of the pigment, and optionally the glass frit, is not greater than 5 micrometres; (ii) screen printing the enamel paste using a printing screen which has a low surface roughness coating surface; (iii) varying the surface tension and viscosity in the enamel paste layer applied to provide a smoothing effect; and (iv) inkjet printing the enamel rather than using screen printing. US20170135160 describes that the composition of the enamel paste is not specific to the application. It is disclosed that for enamel layers produced by screen printing, the mean roughness Rₐ was 0.69 micrometres (i.e. too rough, being above the 0.5 micrometre threshold). For the layers applied by an inkjet technique, the roughness obtained was substantially reduced and a mean roughness of the order of 0.14 micrometres was obtained using an enamel composition produced by Johnson-Matthey (JM1L6027).

The present invention is directed to an improved enamel paste composition specifically tailored for use in a method such as that described in US20170135160.

### SUMMARY

As described in the background US20170135160 indicates that the composition of the enamel paste is not specific for use with thin functional coatings beyond the characteristics of the particle size of the glass frit and pigment and the viscosity of the enamel paste provided by the organic carrier medium. US20170135160 does not give any information about the types of glass frit used in the enamel beyond the use of a commercially available enamel composition from Johnson Matthey. Furthermore, there is no indication that the chemical composition of the glass frit will have any effect on the surface roughness of the enamel and the subsequent effect on the thin functional coating deposited thereon. Rather, US20170135160 indicates that a smoother enamel surface can be achieved by using small particle size pigment in the enamel composition and also suggests modifications to the printing process used to deposit the enamel.

The present inventors have developed an improved enamel paste formulation for the application described in US20170135160. Specifically, the improved enamel paste formulation comprises a composition which has the following characteristics:
(i) a glass frit composition which has a low firing (melting) temperature such that the glass frit can soften and flow at a low firing temperature in order to provide a smooth enamel layer at low temperatures for application of a thin coating thereon;
(ii) a glass frit composition which has a high crystallization temperature, such that the glass enamel does not crystallize and damage the thin functional coating disposed thereon during heating and bending of the coated glass article;
(iii) a glass frit composition which meets the characteristics of (i) and (ii) while also having good silver hiding and UV blocking characteristics after heating and bending of the coated glass article.

That is, the chemical composition of the glass frit component of the enamel paste has an impact on the quality of a thin coating deposited thereon and the resultant coated glass article. In particular, the glass frit must be tailored to have a low firing temperature and a high crystallization temperature to yield a low roughness surface enamel layer and avoid damage of the thin functional coating, both during deposition of the thin functional coating and also during further processing of the coated glass article, i.e. heating and bending of the coated glass article. The enamel must also have good silver hiding and UV blocking properties, which are affected by the type of glass frit and the firing temperature as well as the pigment. The present specification thus provides an enamel paste composition tailored for application of thin functional 35 coatings thereon. The enamel paste comprises:
30 to 40% by weight of a bismuth silicate glass frit;
20 to 30% by weight of a zinc silicate glass frit;
15 to 25% by weight of a pigment; and
10 to 20% by weight of an organic carrier medium,
wherein the bismuth silicate glass frit comprises at least silicon, bismuth, boron, and lithium, and is free of lead and cadmium,
wherein the zinc silicate glass frit comprises at least silicon, zinc, sulphur, and lithium, and is free of lead, cadmium, and bismuth,
wherein the glass frits and the pigment in the enamel paste each have a D90 particle size distribution of less than 15 micrometres, and
wherein the enamel paste has a viscosity between 5 and 150 Pa·s⁻¹ at a shear rate of 100 s⁻¹.

The zinc silicate frit brings silver hiding properties to the enamel. The bismuth silicate frit allows the enamel to be processed at low temperature and develops a smooth surface at a low firing temperature. The frits also have a high crystallization temperature. As such, a combination of the two frits provides a low firing temperature smooth surface, silver hiding properties over a large range of temperature, and a high crystallization temperature.

Optionally, the bismuth silicate glass frit has the following composition (expressed as oxide components:

| Component | Mol % |
|---|---|
| SiO₂ | 45-55 |
| Bi₂O₃ | 15-25 |
| B₂O₃ | 10-20 |
| Li₂O | 2-10 |
| Al₂O₃ | 0-5 |
| ZrO₂ | 0-5 |
| K₂O | 0-1 |
| MgO | 0-1 |
| CaO | 0-1 |

Optionally, the zinc silicate glass frit has the following composition:

| Component | Mol % |
|---|---|
| SiO₂ | 45-55 |
| ZnO | 20-30 |
| Li₂O | 1-10 |
| S | 1-10 |
| B₂O₃ | 0-10 |
| Na₂O | 0-10 |
| F | 0-10 |
| MnO | 0-10 |
| CaO | 0-1 |
| Fe₂O₃ | 0-1 |
| MgO | 0-1 |

The pigment is optionally a CuCr black pigment.

The present specification also provides for the use of the enamel paste to fabricate a coated glass article comprising a glass substrate, an enamel layer disposed on the glass substrate, and a thin coating having a thickness of no greater than 0.5, 0.4, 0.3, 0.2 or 0.1 micrometres disposed on the enamel layer.

The enamel paste is tailored for a method of fabricating a coated glass article, including, but not limited to, the type of coated glass articles described in US20170135160. The method comprises:
depositing an enamel paste on a portion of a glass substrate;
firing the enamel paste at a temperature T1 to form an enamel layer;
depositing a thin coating over at least a portion of the enamel layer, the thin coating having a thickness of no greater than 0.5, 0.4, 0.3, 0.2 or 0.1 micrometres;
firing and bending the glass substrate with the enamel layer and the thin coating thereon at a temperature T2 which is greater than T1 to form the coated glass article,
wherein the enamel paste is formulated to have a firing temperature lower than T1 and a crystallization temperature higher than T2.

The paste composition as previously described can be used in the method. However, it is also envisaged that for different applications the firing temperature T₁ and the bending temperature T₂ may differ. In this case, the formulation of the enamel paste can be modified to ensure that it has a firing temperature lower than T₁ and a crystallization temperature higher than T₂ in order to ensure that a thin film coating disposed on the enamel is not damaged during processing, while also achieving the colour characteristics and/or silver hiding characteristics required for an end application after processing at T₂. As such, the method of this specification is not limited to the specific enamel paste composition tailored for an end application having a specifically defined T₁ and T₂. That is, a skilled person in the art of enamel paste formulation will be able to utilize the teachings of this specification to modify the composition of the paste described herein so as to be suitable for thin film coating applications having different T₁ and T₂ values and utilizing different bending processes including, for example, sag bending, press bending, and variants thereof.

Advantageously, the enamel layer has a roughness Rₐ of no more than 1, 0.7, 0.5, or 0.3 micrometres and/or a roughness R_{z} of no more than 5, 4, 3, 2, or 1 micrometre. Furthermore, for obscuration applications, the enamel layer advantageously has an L-value of no more than 5, 4.5, 4, or 3.5.

The thin coating can be deposited via a vacuum deposition process such as a cathode sputtering process as is the case for the application described in US20170135160. The thin coating may be deposited over at least a portion of the glass substrate in addition to being deposited over at least a portion of the enamel layer. Furthermore, as also described in US20170135160, the thin coating can be electrically conductive, optionally comprising a plurality of sub-layers (e.g. 2 or 3 silver sub-layers), and at least one electrical connector can be deposited on the thin coating over the enamel layer.

While the enamel pastes of the present invention have been developed for applications such as described in US20170135160, it is envisaged that enamel pastes according to the present specification will be useful for other functional thin film coatings on glass substrates including electrical, optical, and thermal functional coatings.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows an automotive glass panel configuration of the type described in US20170135160;

FIG. 2 shows a flow diagram of the steps involved in providing a coated glass sheet for use in the automotive glass panel configuration shown in FIG. 1;

FIGS. 3(a) and 3(b) show flow diagrams illustrating that following the method of FIG. 2 leads to damage of a thin film during processing unless the firing (melting) temperature of the enamel paste composition is lower than the firing temperature T₁ and the crystallization temperature of the enamel paste composition is higher than the bending temperature T₂;

FIG. 4 shows the colour development characteristics of an enamel layer formed using enamel paste composition according to this specification in terms of its L-value vs firing temperature, the enamel being formulated to have a low L-value at the final firing (bending) temperature T₂ of the coated glass manufacturing method without crystallization; and

FIG. 5 shows the silver hiding characteristics of an enamel layer formed using an enamel paste composition according to this specification in terms of its dE value vs firing temperature, the enamel being formulated to have a low dE value (good silver hiding) at the final firing (bending) temperature T₂ of the coated glass manufacturing method without crystallization.

### DETAILED DESCRIPTION

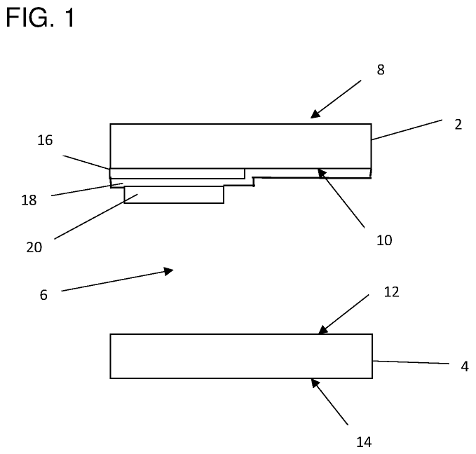

As described in the background section, the glass panel configuration described in US20170135160 is shown in FIG. 1 and comprises two glass sheets 2, 4 united by an interlayer sheet 6. The outer side 8 of outer glass sheet 2 is conventionally designated side 1, the inner side 10 of outer glass sheet 2 is conventionally designated side 2, the side 12 of the inner glass sheet 4 which faces the outer glass sheet 2 is conventionally designated side 3, while the interior side 14 of inner glass sheet 4 is conventionally designated side 4. An enamel layer 16 is formed on side 2 of the outer glass sheet. A thin coating 18 is formed over the enamel layer 16 and over un-enamelled portions of side 2 of the outer glass sheet. An electrical bus bar 20 is formed on the thin coating 18 over the enamel layer 16. The glass sheets 2, 4 are fired and shaped and then laminated with the interlayer sheet 6 to form the glass panel.

It should be noted that while the configuration shown in FIG. 1 has the enamel layer 16 and thin coating 18 disposed on side 2 of a laminated glass panel comprising two glass sheets 2, 4, the present invention is not limited to this configuration. For example, the enamel layer and thin coating could be applied to a different side of such a laminated glass panel or may be applied to a glass panel comprising a single glass sheet.

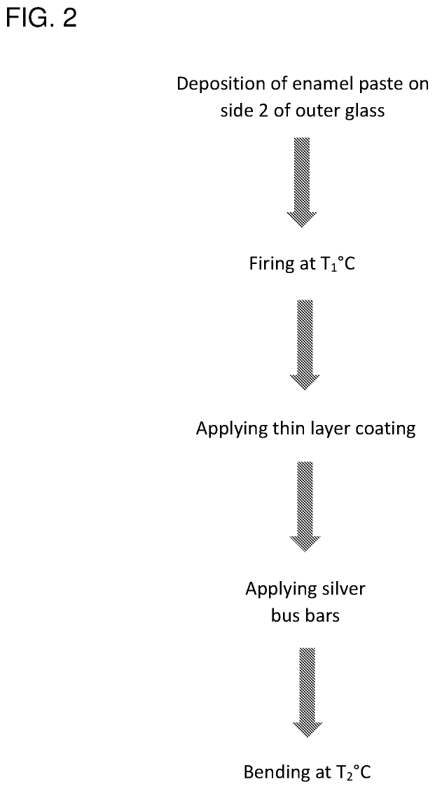

FIG. 2 shows a flow diagram of the steps involved in providing the outer coated glass sheet 2 of the automotive glass panel configuration shown in FIG. 1. The method comprises: depositing enamel paste on side 2 of the outer glass sheet; firing at a temperature T₁° C.; applying a thin layer coating over the enamel and over un-enamelled portions of the outer glass sheet; applying silver bus bars on the thin layer coating over the enamelled portions of the outer glass sheet; and bending the coated glass sheet at a temperature T₂° C.

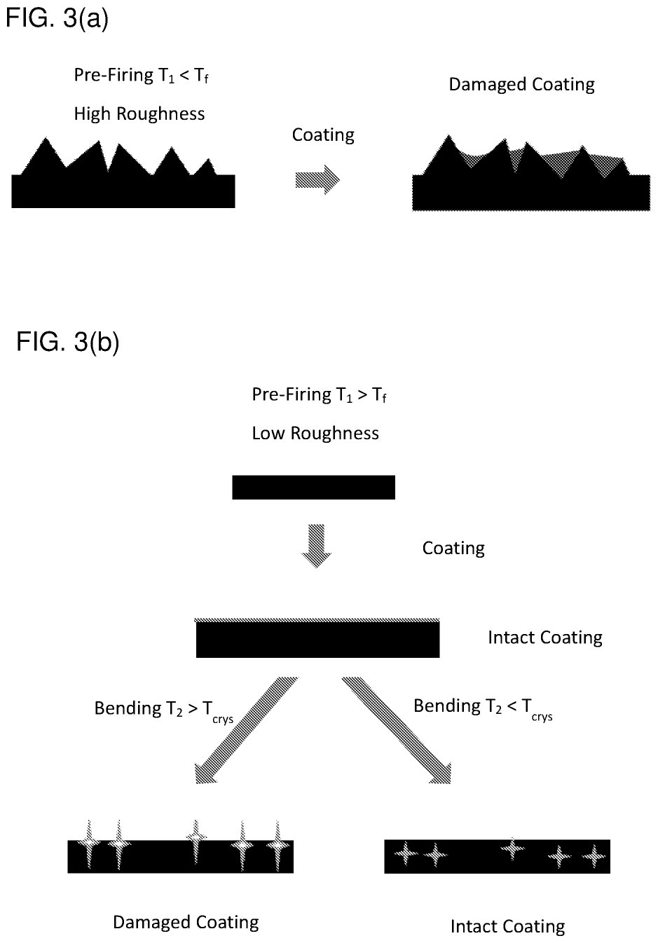

FIGS. 3(a) and 3(b) show flow diagrams illustrating that following the method of FIG. 2 leads to damage of the thin film coating during processing unless the firing (melting) temperature of the enamel paste composition is lower than the firing temperature T₁ and the crystallization temperature of the enamel paste composition is higher than the bending temperature T₂.

FIG. 3(a) shows that if paste is initially fired at a temperature T₁ which is below the firing/melting temperature of the glass frit, which is the case in a standard pre-firing step designed to merely remove organic carrier medium rather than melt and fuse the glass frit, then a rough surface results which can lead to a damaged thin film coated when deposited onto such a surface using, for example, a vapour deposition technique.

FIG. 3(b) shows that even if the enamel paste is initially fired at a temperature T₁ which is above the firing/melting temperature of the glass frit to provide a smooth surface on which to deposit a thin film coating, the thin film coating can be subsequently damaged during bending of the coated glass sheet if the bending temperature T₂ is above the crystallization temperature of the glass enamel.

As such, FIGS. 3(a) and 3(b) illustrate that the glass frit in the enamel composition must have both a firing/fusing/melting temperature lower than T₁ to produce a low surface roughness after firing at T₁ and a crystallization temperature higher than T₂ in order to ensure that the thin film coating is deposited in an undamaged form and remains in an undamaged form during processing (bending) at T₂.

In addition to the above, the resultant enamel must meet the functional characteristics required for the application. For example, in the automotive glass panel application of FIG. 1, the enamel must have good optical characteristic and good properties to: (i) shield silver hiding glue/adhesive from UV decomposition; and (ii) mask the silver bus bars disposed behind the enamel. These characteristics are dependent on the chemical composition of the glass frit and also on the final firing/bending temperature T₂ used to process the enamel coated glass sheet. As such, for this application the enamel paste composition must be tailored to meet a plurality of requirements including a firing/fusing/melting temperature lower than T₁, a crystallization temperature higher than T₂, and also meet the optical characteristics and silver hiding properties required for the end application after processing at T₂. The enamel must also be chemically and structurally resistant to the thin film coating and vapour deposition method of fabricating the thin film coating over the enamel. Furthermore, for automotive applications it is required that the enamel is acid resistant (0.1N H₂SO₄ for 4 hours at 80° C.) and that the coated glass sheet meets a minimum mechanical strength specification.

The present specification provides s an enamel paste composition which meets all the aforementioned requirements for an enamel suitable to be used in combination with thin functional coatings, such as self-heated or IR reflective coatings.

The enamel paste comprises: (1) a bismuth silicate glass frit; (2) a zinc silicate glass frit; (3) a pigment; and (4) an organic carrier. Details of an example for the two frit compositions in terms of equivalent oxides are provided below.

### Bismuth Silicate Frit:

| Component | Mol % | Mass % |
|---|---|---|
| SiO₂ | 51.18 | 21.70 |
| Bi₂O₃ | 19.46 | 63.97 |
| B₂O₃ | 16.12 | 7.92 |
| Li₂O | 6.21 | 1.31 |
| Al₂O₃ | 3.00 | 2.16 |
| ZrO₂ | 2.55 | 2.20 |
| K₂O | 0.76 | 0.51 |
| MgO | 0.37 | 0.10 |
| CaO | 0.35 | 0.14 |

### Zinc Silicate Frit:

| Component | Mol % | Mass % |
|---|---|---|
| SiO₂ | 49.09 | 47.11 |
| ZnO | 24.35 | 31.64 |
| Li₂O | 7.82 | 3.73 |
| B₂O₃ | 6.91 | 7.68 |
| Na₂O | 4.82 | 4.77 |
| F | 2.34 | 0.71 |
| MnO | 2.13 | 2.41 |
| S | 1.71 | 0.87 |
| CaO | 0.59 | 0.53 |
| Fe₂O₃ | 0.20 | 0.51 |
| MgO | 0.04 | 0.03 |

The pigment can be an automotive back pigment such as a CuCr black pigment.

The frits and pigment are milled to a desired particle size distribution of D90<15 micrometres and mixed with an organic carrier formulation to create a paste with a viscosity between 5 and 150 Pa·s⁻¹ at a shear rate 100 s⁻¹. An example of the paste formulation is provided in the table below:

| | | Ratio |
|---|---|---|
| Intermediates | Description | (wt %) |
| Frit 1 | Pb/Cd/Bi free Zn/S/Li frit | 25.6 |
| Frit 2 | Pb/Cd free Li/Bi/Si frit | 38.4 |
| Pigment | Black pigment | 21.4 |
| Organic Media | Solvent/Thinner/Thixotropic agent | 14.6 |

The novelty of this paste formulation lies in the subtle mix of properties brought to the enamel to fit the process of producing a self-heated laminated motor vehicle glass panel. Self-heated windshields are relatively new products that have been brought to the market in the past 5 years at the time of writing, and the present specification enables an improvement in performance for such self-heated windshields. As previously indicated, key characteristics of the enamel paste formulation include: (i) low firing temperature; (ii) smooth surface after firing; (iii) good silver hiding properties; and (iv) high crystallization temperature. The zinc silicate frit brings silver hiding properties to the enamel. The bismuth silicate frit allows the enamel to be processed at low temperature and develops a smooth surface at a low firing temperature. Both frits have a high crystallization temperature. The combination of the two frits thus provides a low firing temperature smooth surface, silver hiding properties over a large range of temperatures, a high and crystallization temperature to avoid crystallization during bending of the coated glass sheet. This combination of features enables a nanometre scale silver coating to be applied over the enamel and subsequently subjected to a bending procedure without damaging the coating.

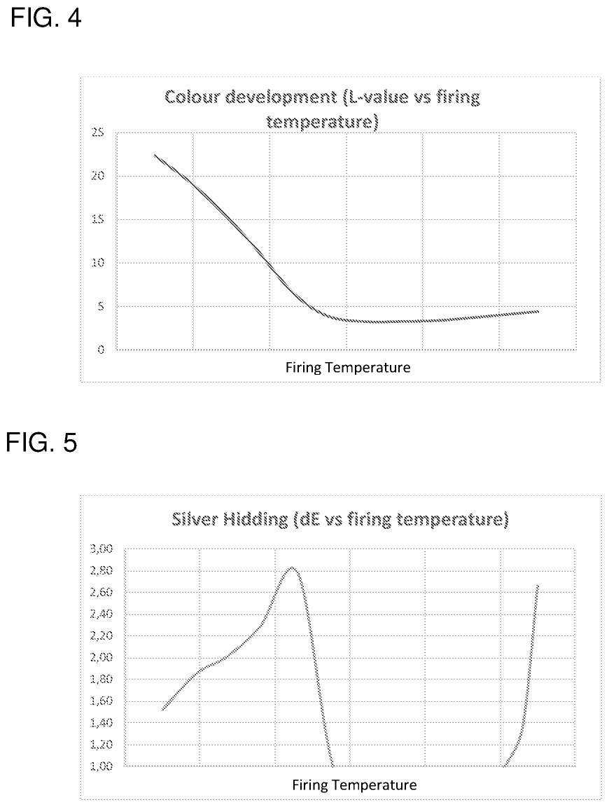

In addition to the above, the enamel paste composition provides an enamel layer after firing at T2 which has good optical and silver hiding characteristics. FIG. 4 shows the colour development characteristics of an enamel layer formed using the enamel paste composition in terms of its L-value vs firing temperature, the enamel being formulated to have a low L-value at the final firing (bending) temperature T₂ of the coated glass manufacturing method without crystallization. FIG. 5 shows the silver hiding characteristics of an enamel layer formed using the enamel paste composition in terms of its dE value vs firing temperature, the enamel being formulated to have a low dE-value (good silver hiding) at the final firing (bending) temperature T₂ of the coated glass manufacturing method without crystallization.

The resulting paste can thus be used to build an improved laminated motor vehicle glass panel. The enamel paste is deposited on a glass substrate, typically a soda-lime glass, dried at a given temperature and fired in order to obtain a smooth enamel surface. Subsequently, a thin multilayer silver coating is deposited over the glass sheet and the enamel, to form either a resistive heating element or an IR reflective barrier, after which bus bars are deposited over the enamel contacting the thin coating. The coated glass sheet is then heated and bent to form a shaped windshield component.

The specific paste composition as described above has been tailored for a specific windshield manufacturing process having specific T₁ and T₂ temperatures. However, it is also envisaged that for different applications the firing temperature T₁ and the bending temperature T₂ may differ. In this case, the formulation of the enamel paste can be modified to ensure that it has a firing temperature lower than T₁ and a crystallization temperature higher than T₂ in order to ensure that a thin film coating disposed on the enamel is not damaged during processing, while also achieving the colour characteristics required for an end application after processing at T₂. As such, the method of this specification is not limited to the specific enamel paste composition tailored for an end application having a specifically defined T₁ and T₂. That is, a skilled person in the art of enamel paste formulation will be able to utilize the teachings of this specification and modify the composition of the paste described herein to be suitable for thin film coating applications having different T₁ and T₂ values. The key essential features of any modified paste are that the formulation of the enamel paste has a firing temperature lower than T₁, a crystallization temperature higher than T₂ in order to ensure that a thin film coating disposed on the enamel is not damaged during processing, and also that it achieves the desired optical characteristics required for an end application after processing at T₂. Variants of the example described herein can achieve functional modifications for such end applications. As such, variants may fall within the ranges of frit compositions defined in the summary section, although it is also envisaged that a combination of different frit types could also meet the functional requirements of the method as described herein. Accordingly, while this invention has been particularly shown and described with reference to certain examples, it will be understood to those skilled in the art that various changes in form and detail may be made without departing from the scope of the invention as defined by the appended claims.

1. An enamel paste comprising:
30 to 40% by weight of a bismuth silicate glass frit;
20 to 30% by weight of a zinc silicate glass frit;
15 to 25% by weight of a pigment; and
10 to 20% by weight of an organic carrier medium,
wherein the bismuth silicate glass frit comprises at least silicon, bismuth, boron, and lithium, and is free of lead and cadmium,
wherein the zinc silicate glass frit comprises at least silicon, zinc, sulphur, and lithium, and is free of lead, cadmium, and bismuth,
wherein the glass frits and the pigment in the enamel paste each have a D90 particle size distribution of less than 15 micrometres, and
wherein the enamel paste has a viscosity between 5 and 150 Pa·s⁻¹ at a shear rate of 100 s⁻¹.

2. The enamel paste according to claim 1,
wherein the bismuth silicate glass frit has the following composition:

| Component | Mol % |
|---|---|
| SiO₂ | 45-55 |
| Bi₂O₃ | 15-25 |
| B₂O₃ | 10-20 |
| Li₂O | 2-10 |
| Al₂O₃ | 0-5 |
| ZrO₂ | 0-5 |
| K₂O | 0-1 |
| MgO | 0-1 |
| CaO | 0-1 |

3. The enamel paste according to claim 1,
wherein the zinc silicate glass frit has the following composition:

| Component | Mol % |
|---|---|
| SiO₂ | 45-55 |
| ZnO | 20-30 |
| Li₂O | 1-10 |
| S | 1-10 |
| B₂O₃ | 0-10 |
| Na2O | 0-10 |
| F | 0-10 |
| MnO | 0-10 |
| CaO | 0-1 |
| Fe₂O₃ | 0-1 |
| MgO | 0-1. |

4. The enamel paste according to claim 1,
wherein the pigment is a CuCr black pigment.

5. The enamel paste according to claim 1 for fabricating a coated glass article comprising a glass substrate, an enamel layer disposed on the glass substrate, and a thin coating having a thickness of no greater than 0.5 micrometres disposed on the enamel layer.

6. A method of fabricating a coated glass article, the method comprising:
depositing an enamel paste according to claim 1 on a portion of a glass substrate;
firing the enamel paste at a temperature T1 to form an enamel layer;
depositing a thin coating over at least a portion of the enamel layer, the thin coating having a thickness of no greater than 0.5 micrometres;
firing and bending the glass substrate with the enamel layer and the thin coating thereon at a temperature T2 which is greater than T1 to form the coated glass article,
wherein the enamel paste is formulated to have a firing temperature lower than T1 and a crystallization temperature higher than T2.

7. The method according to claim 6,
wherein the enamel layer has a roughness Rₐ of no more than 1 micrometre and/or a roughness R_{z} of no more than 5 micrometres.

8. The method according to claim 6,
wherein the enamel layer has an L-value of no more than 5.

9. The method according to claim 6,
wherein the thin coating is deposited over at least a portion of the glass substrate in addition to being deposited over at least a portion of the pre-fired enamel layer.

10. The method according to claim 6,
wherein the thin coating is electrically conductive and at least one electrical connector is deposited on the thin coating over the pre-fired enamel layer.

11. The method according to claim 6,
wherein the thin coating comprises a plurality of sub-layers.

12. The method according to claim 6,
wherein the thin coating is deposited via a vacuum deposition process.

13. The method according to claim 6,
wherein the thin coating is no more than 0.4, 0.3, 0.2 or 0.1 micrometres in thickness.

14. A coated glass article fabricated according to the method of claim 6.

15. The enamel paste according to claim 2,
wherein the zinc silicate glass frit has the following composition:

| Component | Mol % |
|---|---|
| SiO₂ | 45-55 |
| ZnO | 20-30 |
| Li₂O | 1-10 |
| S | 1-10 |
| B₂O₃ | 0-10 |
| Na2O | 0-10 |
| F | 0-10 |
| MnO | 0-10 |
| CaO | 0-1 |
| Fe₂O₃ | 0-1 |
| MgO | 0-1. |

16. The enamel paste according to claim 2,
wherein the pigment is a CuCr black pigment.

17. The enamel paste according to claim 2 for fabricating a coated glass article comprising a glass substrate, an enamel layer disposed on the glass substrate, and a thin coating having a thickness of no greater than 0.5 micrometres disposed on the enamel layer.

18. A method of fabricating a coated glass article, the method comprising:
depositing an enamel paste according to claim 2 on a portion of a glass substrate;
firing the enamel paste at a temperature T1 to form an enamel layer;
depositing a thin coating over at least a portion of the enamel layer, the thin coating having a thickness of no greater than 0.5 micrometres;
firing and bending the glass substrate with the enamel layer and the thin coating thereon at a temperature T2 which is greater than T1 to form the coated glass article,
wherein the enamel paste is formulated to have a firing temperature lower than T1 and a crystallization temperature higher than T2.

19. The method according to claim 18,
wherein the enamel layer has a roughness Rₐ of no more than 1 micrometre and/or a roughness R_{z} of no more than 5 micrometres.

20. The method according to claim 7,
wherein the enamel layer has an L-value of no more than 5.
